(19) United States
(12) Patent Application Publication
(10) Pub. No.: US 2014/0370255 A1
(43) Pub. Date: Dec. 18, 2014

(54) Method of Producing a Coextrusion Blown Film

(71) Applicant: Alros Products Limited, Toronto (CA)

(72) Inventors: Jae BAIK, Vaughn (CA); Elvio Cavicchia, Toronto (CA)

(73) Assignee: Alros Products Limited, Toronto (CA)

(21) Appl. No.: 14/160,653

(22) Filed: Jan. 22, 2014

Related U.S. Application Data
(60) Provisional application No. 61/836,354, filed on Jun. 18, 2013.

(51) Int. Cl. B29C 71/00; B29C 47/92; B32B 27/34; B29C 47/00

(52) U.S. Cl. CPC B29C 71/009; B29C 47/0057; B29C 47/92; B29C 47/0026; B29C 47/0004; B32B 27/34
USPC 428/212; 264/510; 264/40.1; 264/515

(57) ABSTRACT

This invention relates to a method of producing a coextrusion blown film is described. The method involves coextruding a blown film having 3 to 11 layers, including a first skin layer and a second skin layer, the first skin layer comprising nylon, and the second skin layer having a different melting temperature than the first skin layer. The film is then cooled before being passed through steam. The method can be used to produce a coextrusion blown film that has reduced curling.

### RELATED APPLICATIONS

This application claims the benefit under 35 U.S.C. 119(e) of U.S. Provisional Patent Application Ser. No. 61/836,354, filed Jun. 18, 2013, which is hereby incorporated by reference.

### FIELD OF THE INVENTION

The present invention relates to a method for producing a film, and in particular a coextrusion blown film.

### BACKGROUND OF THE INVENTION

Blown film extrusion is a process for producing thin plastic films, wherein molten plastic is extruded through an upwards facing annular opening of a die. The molten plastic is extruded as a film tube bubble that is pulled upwards by suitable means, such as for example nip rolls. At the centre of the die, there is an outlet through which air or other gases can be forced into the film tube bubble, so as to adjust the volume of the bubble. As the film tube moves away from the die it cools and solidifies.

In a coextrusion blown film process, multiple materials are extruded simultaneously to produce a multilayered film. Such films can be used for a variety of purposes, such as for example as food barrier bags that help to extend the shelf life of food. Each layer of the coextrusion blown film can be provided to perform a specific function. For example, in the context of a food barrier bag, normally at least one layer is provided to act as a barrier layer, reducing the flow of gases therethrough. A food barrier bag having a low oxygen transmission rate can help to delay food spoilage. Other layers can provide other functions, such as a sealant layer that can be used to seal the film to itself, for example to create a bag. Tie layers can also be provided to bind the different layers to each other.

### SUMMARY OF THE INVENTION

The present invention relates to coextrusion blown films in which nylon is extruded as a skin layer of the film, and a polymer having a different melting temperature is extruded as the other skin layer. During a coextrusion blown film process for producing such a film, the film layers come out of the die in a molten state. As the film cools, the nylon generally crystallizes first, since the melting temperature of nylon is generally higher than that of the other layers. The nylon shrinks as it crystallizes, and because the other layers remain in a molten state, they are able to flow freely and compensate for this shrinkage. However, as the temperature continues to decrease, the remaining layers begin to crystallize and shrink as well. Since the nylon layer is already crystallized, it is unable to compensate for the shrinkage of the other layers. This can cause the resulting film to have a tendency to curl away from the nylon layer.

This tendency to curl can interfere with the intended use of the film. For example, these curls can interfere with mounting the film on packaging machinery. Accordingly, it is an object of the present invention to provide an improved process for producing a coextrusion blown film that reduces or eliminates this tendency of the film to curl.

Nylon is characterized by having highly polar amide groups. Strong hydrogen bonds form between these amide groups, contributing to the high melting temperature, thermal stability, stiffness, abrasion resistance and good barrier properties of nylon layers. The polar amide groups furthermore cause nylon to be hydrophilic, and able to easily absorb water. This absorbed water acts to loosen the intermolecular hydrogen bonding in the nylon, and can increase the toughness, puncture resistance, elasticity, and thermoformability of the nylon.

The applicant has recognized that by applying steam to a coextrusion blown film in which one skin layer is nylon and the other skin layer is a polymer having a different melting temperature, curling can be reduced or eliminated.

Accordingly, in one aspect the present invention resides in a method of producing a coextrusion blown film, the method comprising: coextruding a blown film having 3 to 11 layers, including a first skin layer and a second skin layer, the first skin layer comprising nylon, and the second skin layer having a different melting temperature than the first skin layer; cooling the film; and passing the film through steam.

In another aspect the present invention resides in the aforementioned method, wherein the second skin layer has a lower melting temperature than the first skin layer.

In a further aspect the present invention resides in the aforementioned method, wherein the film is for use as food packaging.

In a still further aspect the present invention resides in the aforementioned method, further comprising: generating the steam by boiling water.

In a still further aspect the present invention resides in the aforementioned method, further comprising: generating the steam with a humidifier.

In a still further aspect the present invention resides in the aforementioned method, further comprising: delivering the steam to the film with an apparatus that is adjustable to regulate at least one of: a distance of the apparatus from the film, an amount of steam delivered to the film, and a temperature of the steam.

In a still further aspect the present invention resides in the aforementioned method, further comprising: assessing at least one of: a degree of curling of the film, a humidity of surrounding air, and a moisture content of the film.

In a still further aspect the present invention resides in the aforementioned method, wherein the film has a thickness of 20-250 micron.

In a still further aspect the present invention resides in the aforementioned method, wherein the film is extruded as a tube, and the first skin layer forms an outside of the tube.

In a still further aspect the present invention resides in the aforementioned method, wherein the heat is applied by pressing a heated sealing bar against the first skin layer.

In a still further aspect the present invention resides in the aforementioned method, wherein the film is passed through the steam to reduce curling of the film.

In a still further aspect the present invention resides in the aforementioned method, wherein the first skin layer is polyamide 6, polyamide 666, or a blend of two or more of polyamide 6, polyamide 66, and polyamide 666.

In a still further aspect the present invention resides in the aforementioned method, wherein the second skin layer is a sealant material selected from the group consisting of: polyethylene, ionomer, ethylene-vinyl acetate, ethylene with methacrylic acid, and ethylene with acrylic acid.

In a still further aspect the present invention resides in the aforementioned method, wherein the film comprises a barrier layer selected from the group consisting of: ethylene vinyl alcohol copolymer, polyamide 6, polyamide 666, and polyvinylidene chloride.

In a still further aspect the present invention resides in the aforementioned method, wherein a temperature of the steam is 40 to 100° C.

In a still further aspect the present invention resides in a coextrusion blown film produced by the aforementioned method, wherein the film has reduced curling in comparison with a film that has not been passed through steam, but which is otherwise identical.

In a still further aspect the present invention resides in a method of producing a coextrusion blown film, the method comprising: coextruding a tubular film having 3 to 11 layers, including a nylon skin layer forming an outer surface of the tubular film; cooling the film, with the nylon skin layer crystallizing before the other layers; assessing whether the film is curling; and if the film is curling, passing the film through steam to reduce the curling.

In a further aspect the present invention resides in the aforementioned method, further comprising: delivering the steam to the film with an apparatus comprising a first steam expelling member and a second steam expelling member, the first steam expelling member being positioned on a first side of the film and the second steam expelling member being positioned on a second side of the film, the first and second steam expelling members each being adjustable to move towards and away from the film; and adjusting the position of the first and second steam expelling members relative to the film.

### BRIEF DESCRIPTION OF THE DRAWINGS

Reference may now be made to the following detailed description taken together with the accompanying drawings in which:

FIG. 1 shows a die coextruding a blown film;

FIG. 2 shows a detailed cross-sectional view of the film shown in FIG. 1;

FIG. 3 shows a detailed cross-sectional view of a coextruded blown film that is curled;

FIG. 4 shows a side view of a steam delivery apparatus;

FIG. 5 shows a front view of a steam expelling member of the steam deliver apparatus shown in FIG. 4;

FIG. 6 shows a sealing apparatus;

FIG. 7 shows a detailed cross-sectional view of a coextruded blown film with a seal;

FIG. 8 shows a side view of a food barrier bag;

FIG. 9 is a flowchart of a method of producing a coextruded blown film; and

FIG. 10 is a flowchart of an alternate method of producing a coextruded blown film.

### DETAILED DESCRIPTION OF THE PREFERRED EMBODIMENTS

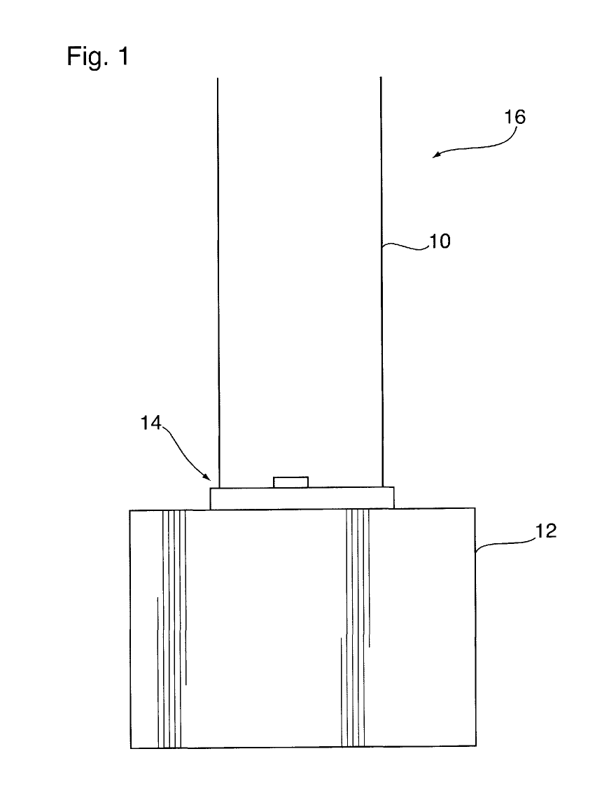

Reference may first be had to FIG. 1, which depicts the coextrusion of a blown film 10 from a die 12. The die 12 continuously receives a number of different molten raw materials and coextrudes them together simultaneously through an upwards or downwards facing annular opening 14. The resulting film 10 is coextruded from the die 12 in the form of a tubular bubble 16.

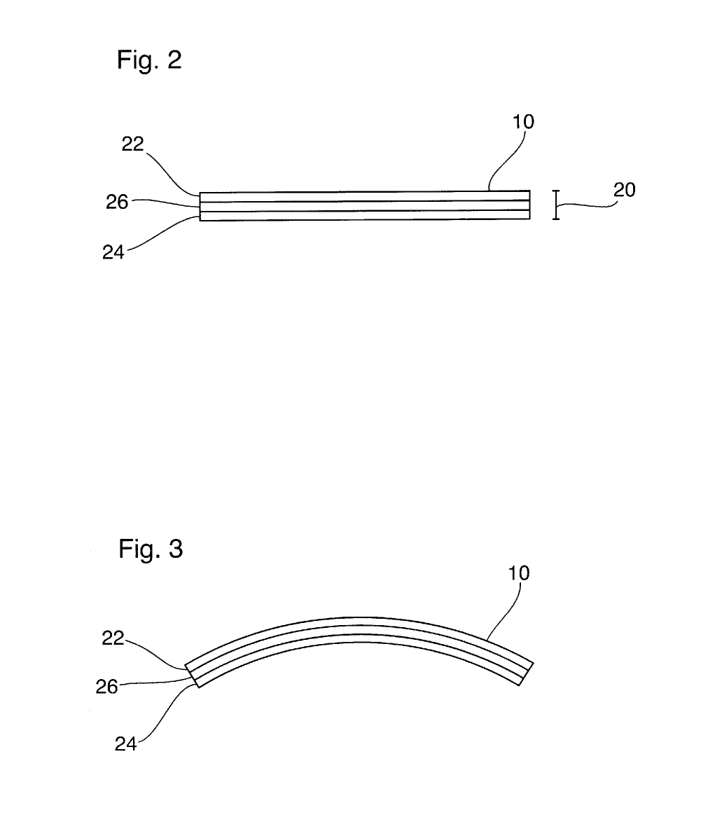

As is best shown in FIG. 2, the film 10 has multiple layers 22, 24 and 26 which are coextruded from the die 12 simultaneously. The film 10 has a thickness 20, which is preferably from 20-250 micron, and has an asymmetric structure, with a first skin layer 22 that is formed from nylon, and a second skin layer 24 that is formed from a different material. In the exemplary embodiment which is depicted in FIG. 2, the second skin layer 24 is formed from polyethylene, and a middle tie layer 26 formed from anhydride-modified polyethylene is provided between the first and second skin layers 22 and 24 to help bind the skin layers 22 and 24 together. However, this particular arrangement of layers 22, 24 and 26 is not required. Rather, any desired asymmetric arrangement having a nylon skin layer 22 and a second skin layer 24 formed from a different material could be selected. Furthermore, the film 10 is not limited to having 3 layers 22, 24 and 26, but rather could have up to 11 different layers. The film 10 could incorporate any suitable materials for forming a coextruded blown film 10 as known to a person skilled in the art, such as for example polyethylene, ionomer, ethylene vinyl alcohol copolymer, ethylene vinyl acetate, tie resins, polypropylene, ethylene and methacrylic acid or acrylic acid.

As the film 10 is extruded, it is pulled away from the die 12. When it is initially extruded, the layers 22, 24 and 26 are in a molten state. As the film 10 moves away from the die 12, it begins to cool. As the film 10 cools, the nylon layer 22 crystallizes first, since the melting temperature of nylon is higher than that of layers 24 and 26. The nylon layer 22 shrinks as it crystallizes, and because layers 24 and 26 remain in a molten state, they are able to flow freely and compensate for this shrinkage. However, as the temperature continues to decrease, remaining layers 24 and 26 begin to crystallize and shrink as well. Since the nylon layer 22 is already crystallized, it is unable to compensate for the shrinkage of layers 24 and 26. This can cause the resulting film 10 to have a tendency to curl away from the nylon layer 22, as is shown in FIG. 3.

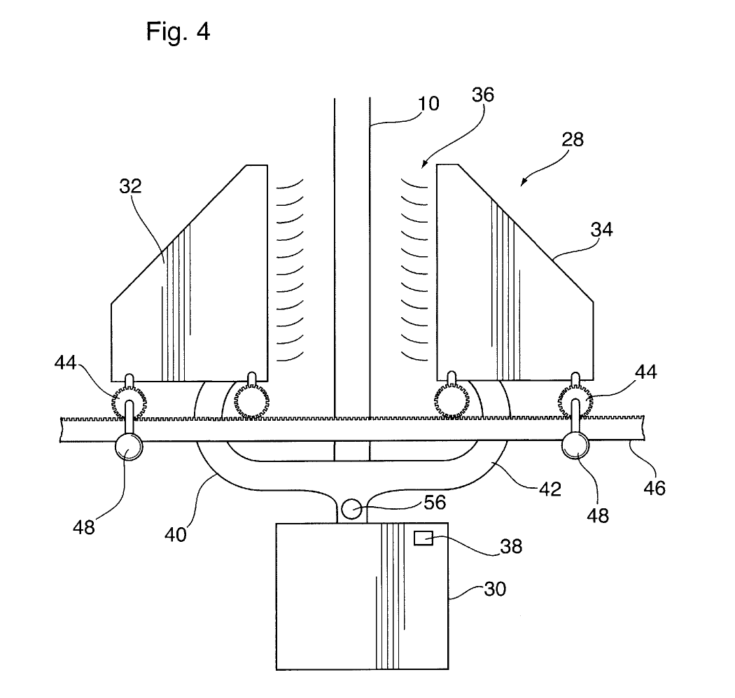

To reduce or eliminate this curling, the film 10 is passed through the steam delivery apparatus 28 depicted in FIG. 4. The steam delivery apparatus 28 includes a steam generator 30 and a pair of steam expelling members 32 and 34. The steam generator 30 produces steam 36 by heating or boiling water. Alternatively, the steam generator 30 could be a humidifier that promotes evaporation of water by, for example, blowing air past a water reservoir or a wick saturated with water. Optionally, the steam generator 30 may include a temperature adjustment control 38 for controlling the temperature of the steam 36. Preferably, the temperature of the steam 36 is 40-100° C.

Steam 36 is delivered from the steam generator 30 to the steam expelling members 32 and 34 through steam inlet channels 40 and 42. The steam inlet channels 40 and 42 are flexible, to accommodate movement of the steam expelling members 32 and 34.

The first steam expelling member 32 and the second steam expelling member 34 are arranged with the film 10 passing therebetween. Extending from each steam expelling member 32, 34 is a rotatable gear 44 mounted on support rack 46. A position adjustment knob 48 extends from each gear 44. When the adjustment knob 48 is rotated, the gear 44 slides along the support rack 46, moving the respective steam expelling member 32 or 34 towards or away from the film 10.

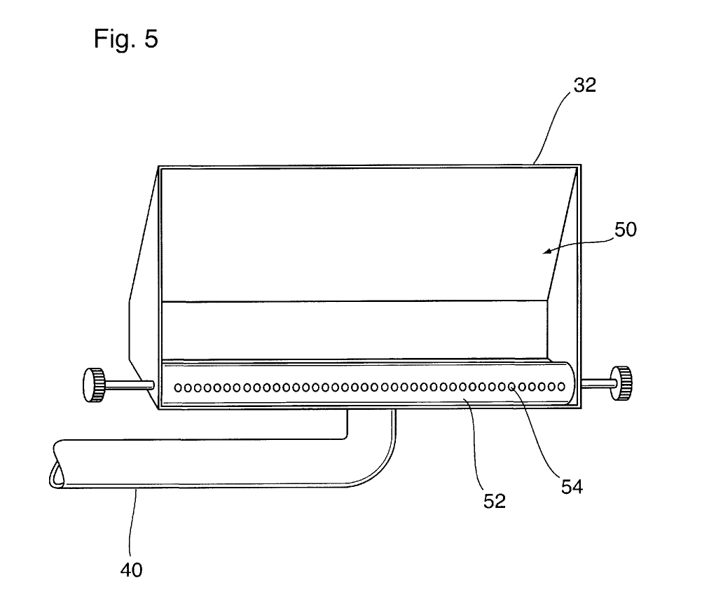

As is best shown in FIG. 5, the first steam expelling member 32 defines a chamber 50. The steam 36 is delivered from the steam inlet channel 40 into a pipe 52 extending along the bottom of chamber 50. The pipe 52 has a plurality of apertures 54 through which the steam 36 is expelled. The second steam expelling member 34 has an identical construction.

By adjusting the position of the steam expelling members 32 and 34, the amount of steam 36 reaching the film 10 can be controlled. When the steam expelling members 32, 34 are moved in close to the film 10, the chambers 50 act to partially trap the steam 36 around the film 10. If less steam 36 is required, the steam expelling members 32 and 34 can be moved away from the film 10. Optionally, the steam delivery apparatus 28 may furthermore include a steam adjustment mechanism 56 for adjusting the amount of steam 36 that is released. For example, the steam adjustment mechanism 56 could control the amount of steam 36 that is delivered to the steam expelling members 32 and 34 by controlling the flow of steam 36 through the steam inlet channels 40 and 42.

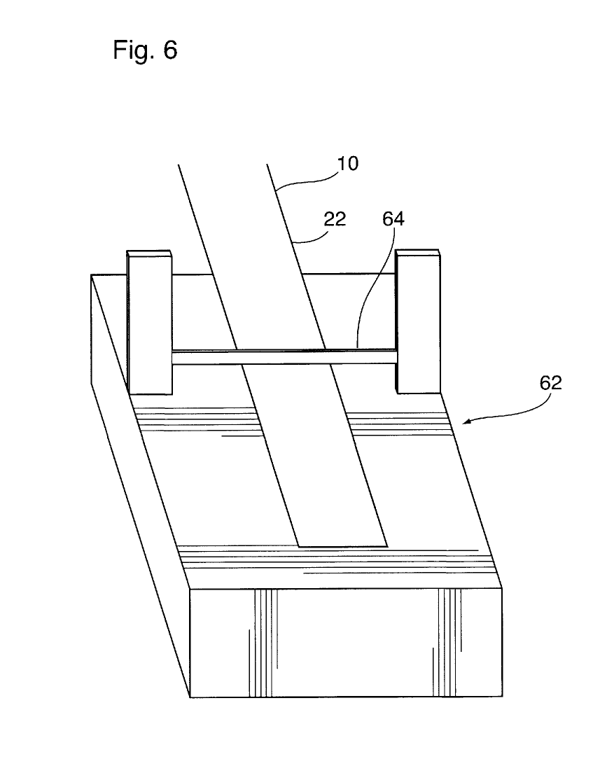

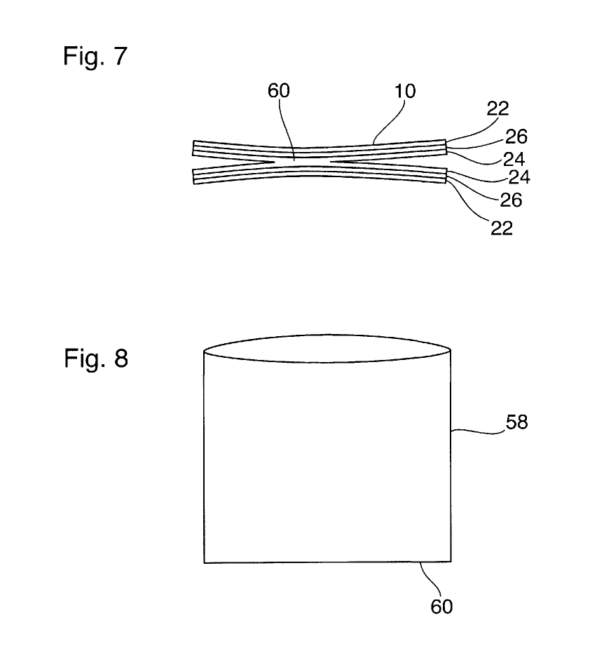

After the film 10 has passed through the steam delivery apparatus 28, it can optionally be rolled up for storage, or can proceed to further processing. In the exemplary embodiment depicted in the Figures, the film 10 is further processed to form a food barrier bag 58. To produce a food barrier bag 58, a seal 60 must be formed in the film 10. This is done by passing the film 10 through a sealing apparatus 62, as shown in FIG. 6. The sealing apparatus 62 includes a heated sealing bar 64. When the tubular film 10 arrives at the sealing apparatus 62 it is in a collapsed state, with the nylon skin layer 22 forming an outside of the collapsed film 10, and the polyethylene skin layer 24 folded against itself. As the film 10 moves through the sealing apparatus 62, the heated sealing bar 64 is periodically pressed against the nylon skin layer 22. The heat diffuses through the film 10, bonding the inner polyethylene layer 24 and forming a seal 60, as shown in FIG. 7. Because the nylon skin layer 22 has a higher melting temperature than the polyethylene layer 24, the nylon layer 22 does not melt. This ensures that the outer nylon skin layer 22 remains intact, and does not stick to the sealing bar 64. The film 10 can then be cut to form a food barrier bag 58, as shown in FIG. 8.

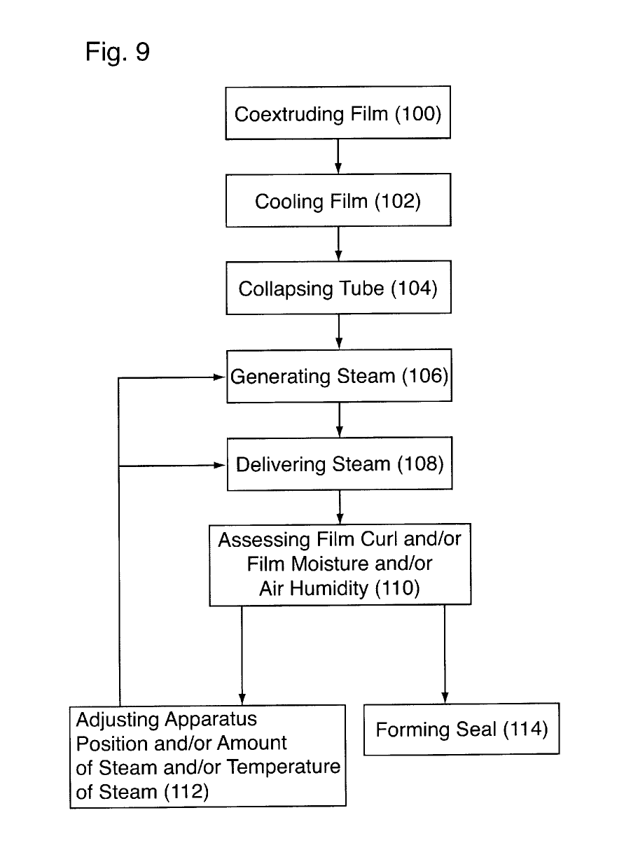

A flow-chart depicting an exemplary method of producing a coextrusion blown film 10 in accordance with the invention is shown in FIG. 9. First, the blown film 10 is coextruded from a die 12 as a tubular bubble 16 (100). The film 10 has 3 to 11 layers which are coextruded from the die 12 simultaneously, including a nylon skin layer 22 and another skin layer 24 formed from a material having a different melting temperature. Preferably, the nylon skin layer 22 forms an outside of the tubular film 10.

As the film 10 moves away from the die 12 it is cooled (102). As the film 10 cools, the nylon layer 22 begins to crystallize first, since it has the highest melting temperature. After the nylon layer 22 crystallizes, the other layers crystallize as well.

Once the film 10 has cooled and solidified, the bubble 16 is collapsed (104), and the tubular film 10 is folded against itself to form a flat sheet. The film 10 is then transported to a steam delivery apparatus 28. The steam delivery apparatus 28 generates steam 36 by boiling or heating water (106), and delivers the steam 36 to the film 10 (108). As the film 10 passes through the steam 36, moisture is absorbed by the nylon skin layer 22.

To optimize the process, one or more parameters can then be assessed (110). For example, the resulting film 10 can be examined to determine whether or not the film 10 is curling. If the film 10 is curling, the process can be adjusted by, for example, increasing the temperature of the steam 36 (112). Increasing the temperature of the steam 36 will increase the amount of moisture that is absorbed by the nylon skin layer 22, further reducing the curling. The steam expelling members 32 and 34 can also be moved closer to the film 10, to increase the amount of steam 36 that reaches the film 10 (112). Furthermore, the amount of steam 36 being expelled from the steam expelling members 32 and 34 can be increased (112). Each of these adjustments can further reduce the curling of the film 10.

The film 10 can also be assessed to determine the moisture content thereof (110). For example, the film 10 may emerge from the steam delivery apparatus 28 wet and sticky. This can interfere with the handling and storage of the film 10, and may necessitate drying of the film 10 before it proceeds to further processing or storage. To reduce the moisture content of the film 10, the steam expelling members 32 and 34 can be moved away from the film 10 and/or the amount of steam 36 expelled can be decreased (112).

It may also be useful to determine the humidity of the air in the facility where the film 10 is being produced (110). If the humidity is high, the film 10 may not require as much steam 36 to prevent curling, since the film 10 is already absorbing moisture from the air. When the air humidity is high, the temperature of the steam 36 can be decreased, the steam expelling members 32 and 34 can be moved away from the film 10, and/or the amount of steam 36 expelled can be decreased (112). Furthermore, if the humidity is so high that no steam 36 is required at all, the steam generator 30 can be turned off entirely. This avoids the unnecessary costs of generating steam 36 that is not required, and furthermore can help to prevent the film 10 from becoming overly moist and sticky when produced under humid conditions. Furthermore, it is not necessary to alter the path of the film 10 to stop the application of steam 36. Rather, the steam generator 30 can simply be turned off, with the film 10 passing through the steam delivery apparatus 28 as it normally would.

Once these adjustments are made, the film 10 can be assessed again (110), and it can be determined whether or not further adjustments (112) are necessary.

Once the steam 36 delivery has been optimized, the resulting film 10 can be rolled up for storage or proceed to further processing. Optionally, a seal 60 can be formed in the film 10 by applying heat to the nylon skin layer 22 of the collapsed tubular film 10 (114). The heat bonds the inner skin layer 24 which is folded against itself, forming the seal 60. The outer nylon skin layer 22 does not melt because it has a higher melting temperature than the skin layer 24.

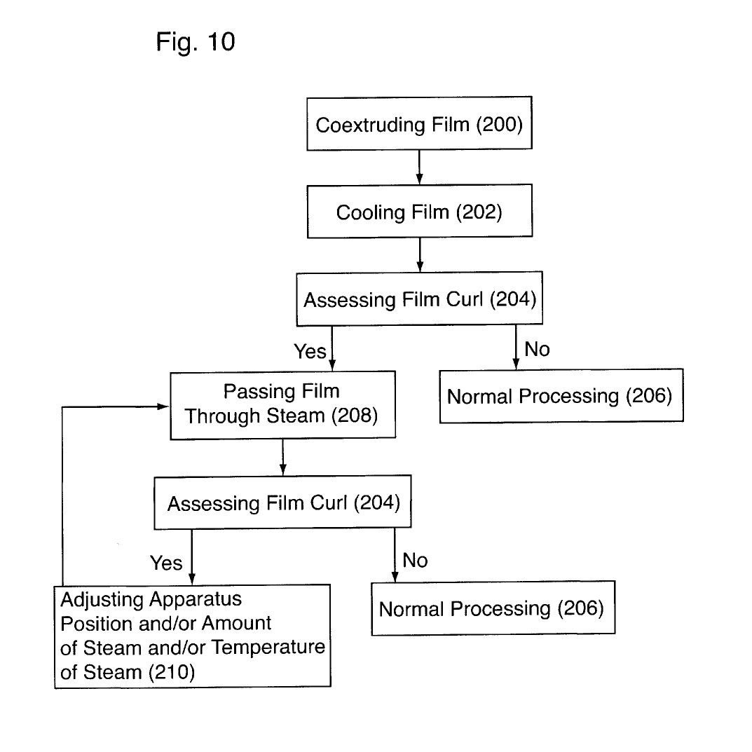

An alternate embodiment of a method of producing a coextrusion blown film 10 in accordance with the invention is shown in FIG. 10. As in the previously described embodiment, the blown film 10 is coextruded from the die 12 (200). As the film 10 moves away from the die 12 it is cooled (202), with the nylon skin layer 22 crystallizing before the other layers. Once the film 10 has solidified, it is then examined to determine whether or not the film is exhibiting unwanted curling (204). If there is little or no curling, the film 10 can proceed to further processing or storage (206). This might occur, for example, if the humidity of the air in the production facility is high. In such circumstances, the nylon skin layer 22 may be able to absorb enough moisture from the air to sufficiently reduce or eliminate the curling of the film 10.

If the film 10 exhibits unwanted curling, the film 10 can be passed through steam 36 (208). The curling of the film 10 can then be assessed again (204), and the process can be adjusted as necessary to achieve optimal steam 36 delivery (210). For example, if the film 10 continues to curl, the process can be adjusted by increasing the temperature of the steam 36. Furthermore, the steam expelling members 32 and 34 can be moved closer to the film 10, and/or the amount of steam 36 being expelled from the steam expelling members 32 and 34 can be increased.

Alternatively, if the curling is eliminated but the application of steam 36 leaves the film 10 overly moist and sticky, the process can be adjusted to move the steam expelling members 32 and 34 away from the film 10 and/or reduce the amount of steam 36 being expelled. Once the steam 36 delivery has been optimized, the film 10 can proceed to further processing or to storage (206).

The method advantageously provides an asymmetric coextruded blown film 10 exhibiting little or no curling. Such a film 10 can be used for a variety of purposes. For example, the film 10 can be used as a food barrier bag 58. Advantageously, the arrangement of the film 10 permits a seal 60 to be easily formed when, for example, producing a bag 58. In particular, heat can be applied to the outer nylon skin layer 22 in order to melt the inner skin layer 24 and form a seal 60. The higher melting temperature of the nylon skin layer 22 ensures that the integrity of the outer skin layer 22 is maintained and that it does not stick to the sealing bar 64.

Although an exemplary embodiment of the process has been described as forming a three layered film 10 with a nylon skin layer 22, a tie layer 26, and a polyethylene skin layer 24, the invention is not so limited. Rather, the process could be used to produce any asymmetric coextruded blown film 10 having 3 to 11 layers, including a nylon skin layer 22 and a skin layer 24 having a different melting temperature than the nylon layer 22. The film 10 could include a number of additional layers having additional functions. For example, the film 10 could include one or more layers provided to act as a barrier to inhibit the passage of gases therethrough. This is important for a film 10 that is to be used as a food barrier bag 58, as having low gas transmission rates, and in particular a low oxygen transmission rate, is important for delaying the spoilage of food. Possible barrier layer materials would be known to a skilled reader, and include for example ethylene vinyl alcohol copolymer (melt temperature range: 155-195° C.), polyamide 6 (typical melt temperature: 220° C.), polyamide 666 (typical melt temperature: 190-195° C.), or polyvinylidene chloride (typical melt temperature: 202° C.).

Furthermore, the inner skin layer 24 need not be made from polyethyelene. Rather, the inner skin layer 24 could be made from any material having a different melting temperature than the nylon skin layer 22. Any materials providing a desired property could be used. For example, the inner skin layer 24 could be selected to provide a sealing function. Possible sealing materials would be known to a person skilled in the art, and include for example polyethylene (melt temperature range: 100-130° C.), ionomer (melt temperature: 98° C.), ethylene-vinyl acetate (melt temperature range: 70-100° C.), ethylene and methacrylic acid or acrylic acid (melt temperature range: 90-110° C.).

The different layers of the film 10 can be held together by tie layers where necessary. A person skilled in the art would be familiar with the various tie layer materials that could be used, and would appreciate which tie layers could be used for holding together various combinations of layers. Possible tie layer materials include, for example, ethylene-vinyl acetate, or anhydride-modified polyethylene.

The nylon skin layer 22 is preferably formed from polyamide 6 (melt temperature about 220° C.). Alternatively, the nylon skin layer 22 could be formed from polyamide 666 (melt temperature about 190-195° C.) or blends of polyamide 6, 66 and/or 666.

Although the film 10 has been described as for use as a food barrier bag 58, the invention is not so limited. Rather, the film 10 could be used for any desired purpose. For example, the film 10 could be used as a packaging material for goods such as electronics or furniture.

Although the invention has been described as using a particular steam delivery apparatus 28, the invention is not strictly so limited. Rather, any apparatus that is capable of delivering steam 36 to the film 10 could be used. For example, the steam 36 could be supplied from another part of the production facility where it is generated primarily for another purpose.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments which are functional, chemical or mechanical equivalents of the specific embodiments and features that have been described and illustrated herein.

1) A method of producing a coextrusion blown film, the method comprising:
coextruding a blown film having 3 to 11 layers, including a first skin layer and a second skin layer, the first skin layer comprising nylon, and the second skin layer having a different melting temperature than the first skin layer;
cooling the film; and
passing the film through steam.

2) The method according to claim 1, wherein the second skin layer has a lower melting temperature than the first skin layer.

3) The method according to claim 1, wherein the film is for use as food packaging.

4) The method according to claim 1, further comprising:
generating the steam by boiling water.

5) The method according to claim 1, further comprising:
generating the steam with a humidifier.

6) The method according to claim 1, further comprising:
delivering the steam to the film with an apparatus that is adjustable to regulate at least one of: a distance of the apparatus from the film, an amount of steam delivered to the film, and a temperature of the steam.

7) The method according to claim 6, further comprising:
assessing at least one of: a degree of curling of the film, a humidity of surrounding air, and a moisture content of the film; and
adjusting at least one of: the distance of the apparatus from the film, the amount of steam delivered to the film, and the temperature of the steam.

8) The method according to claim 1, wherein the film has a thickness of 20-250 micron.

9) The method according to claim 1, wherein the film is extruded as a tube, and the first skin layer forms an outside of the tube.

10) The method according to claim 9, further comprising:
at least partially collapsing the tube so that at least a portion of the second skin layer is folded against itself; and
forming a seal by temporarily applying heat.

11) The method according to claim 10, wherein the heat is applied by pressing a heated sealing bar against the first skin layer.

12) The method according to claim 1, wherein the film is passed through the steam to reduce curling of the film.

13) The method according to claim 1, wherein the first skin layer is polyamide 6, polyamide 666, or a blend of two or more of polyamide 6, polyamide 66, and polyamide 666.

14) The method according to claim 1, wherein the second skin layer is a sealant material selected from the group consisting of: polyethylene, ionomer, ethylene-vinyl acetate, ethylene with methacrylic acid, and ethylene with acrylic acid.

15) The method according to claim 1, wherein the film comprises a barrier layer selected from the group consisting of: ethylene vinyl alcohol copolymer, polyamide 6, polyamide 666, and polyvinylidene chloride.

16) The method according to claim 1, wherein a temperature of the steam is 40 to 100° C.

17) A coextrusion blown film produced by the method defined by claim 1, wherein the film has reduced curling in comparison with a film that has not been passed through steam, but which is otherwise identical.

18) A method of producing a coextrusion blown film, the method comprising:
coextruding a tubular film having 3 to 11 layers, including a nylon skin layer forming an outer surface of the tubular film;
cooling the film, with the nylon skin layer crystallizing before the other layers;
assessing whether the film is curling; and
if the film is curling, passing the film through steam to reduce the curling.

19) The method according to claim 18, further comprising:
adjusting at least one of: an amount of steam delivered to the film, and a temperature of the steam.

20) The method according to claim 18, further comprising:
delivering the steam to the film with an apparatus comprising a first steam expelling member and a second steam expelling member, the first steam expelling member being positioned on a first side of the film and the second steam expelling member being positioned on a second side of the film, the first and second steam expelling members each being adjustable to move towards and away from the film; and
adjusting the position of the first and second steam expelling members relative to the film.
